(19) United States
(12) Patent Application Publication
(10) Pub. No.: US 2026/0310926 A1
(43) Pub. Date: Oct. 8, 2026

(54) SYSTEMS AND METHODS FOR AI-ENABLED DIGITAL MEMORIALIZATION

(71) Applicants: Sophie Ritzman, Alpharetta, GA (US); Landon Ritzman, Alpharetta, GA (US)

(72) Inventors: Sophie Ritzman, Alpharetta, GA (US); Landon Ritzman, Alpharetta, GA (US)

(21) Appl. No.: 19/169,531

(22) Filed: Apr. 3, 2025

(51) Int. Cl. G06N 3/008; G06F 40/284; G06N 3/045; G06T 13/40; G10L 13/047

(52) U.S. Cl. CPC G06N 3/008; G06F 40/284; G06N 3/045; G06T 13/40; G10L 13/047

(57) ABSTRACT

A computer-implemented method of artificial-intelligence enabled digital memorialization may include modeling, via a computing device implementing an artificial intelligence (AI) model, a conversational model based data within an interactive memory system; modeling, via the computing device implementing the AI model, an age progression model based on the interactive memory system; and generating, via the computing device implementing the AI model, a holographic model of an individual, wherein the holographic model is configured to replicate an individual based on the conversational model and the age progression model.

### TECHNICAL FIELD

The embodiments generally relate to the technical field of digital memorialization. More specifically, it pertains to computing systems and methods for preserving and interacting with digital representations of individuals, leveraging advancements in machine learning, natural language processing, and multimedia processing. The invention is applicable to areas such as virtual memorials, AI-driven personalization, and digital heritage preservation.

### BACKGROUND

Conventional systems for digital memorialization systems primarily consist of static online memorial pages, social media tributes, and multimedia storage platforms. These systems allow users to create digital profiles for deceased individuals, where text, images, videos, and messages can be uploaded and shared. Some platforms offer basic interaction features, such as guestbooks or tribute sections, enabling family and friends to contribute memories over time. However, these systems are largely passive and do not provide interactive experiences beyond static content display.

In recent years, advancements in cloud computing and artificial intelligence have led to the development of more sophisticated digital legacy solutions. For example, some services utilize chatbots trained on user-provided data to simulate conversations with a deceased individual. These implementations typically rely on predefined scripts or text-based algorithms, limiting their ability to generate dynamic, contextually rich interactions.

Other systems incorporate image processing and age progression technologies, which allow users to visualize how a person might have aged over time. These applications, however, are generally standalone tools and do not integrate seamlessly into broader digital memorialization platforms.

Holographic rendering technologies have also emerged in various industries, including entertainment and historical preservation. Some memorial applications use holographic projections based on pre-recorded video footage, but these systems are typically expensive, require specialized hardware, and lack real-time adaptability based on user interaction.

While conventional approaches have improved access to digital memorials, they remain limited in personalization, interactivity, and AI-driven adaptability. Existing systems often rely on static content repositories, scripted interactions, or isolated AI applications, without integrating multiple modalities of engagement into a unified experience.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

The disclosed system relates to systems and methods for AI-enabled digital memorialization. More specifically, the invention pertains to computer-implemented techniques leveraging artificial intelligence (AI), machine learning, and holographic modeling to create interactive digital representations of deceased individuals. The system integrates natural language processing (NLP), age progression modeling, and holographic rendering to enable users to interact with AI-generated personas of their lost loved ones.

The disclosed system utilizes cloud computing, neural networks, and multimedia processing to store, analyze, and generate personalized digital memories. By incorporating an AI module using large language models (LLMs), image processing APIs, and cloud-based AI agents, the system facilitates realistic simulations of human conversation and visual representations over time. Furthermore, the invention enhances traditional memorialization methods by introducing dynamic AI-generated experiences, allowing users to engage in conversations, visualize the aging process of individuals, and create immersive holographic projections.

In one aspect, the system may include a recommendation engine configured to provide personalized suggestions for emotional support and resilience based on user engagement, sentiment analysis, and behavioral trends within the platform.

In one aspect, the system may include a periodic self-assessment tool that captures user mood, stress levels, and emotional state to personalize the memorial experience and recommend support resources.

In one aspect, the system may include a virtual memorial system where users can curate and interact with multimedia memories, AI-generated personas, and meaningful content related to their loved ones.

In one aspect, the system may include a user or AI-based tagging system configured to allows users or the AI system to tag and organize images, videos, and memories based on people, events, themes, or emotional significance for easier retrieval and storytelling.

In one aspect, the system may include a database and support module configured to connect users to a network of licensed counselors, grief coaches, or peer support groups for additional human-guided emotional care.

This disclosed system may find applications in digital heritage preservation, grief support, personalized AI interaction, and virtual memory archiving, offering a novel approach to preserving and interacting with digital legacies.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a system architecture diagram, according to some embodiments;

FIG. 2 illustrates an application program and modules in communication with the computing system, according to some embodiments;

FIG. 3 illustrates a block diagram of a method of generating a holographic model based on input user data, according to some embodiments;

FIG. 4 illustrates a block diagram of a method of user data processing architecture, according to some embodiments; and

FIG. 5 illustrates a block diagram of a method of performing AI-enabled digital memorialization, according to some embodiments;

FIG. 6 illustrates a flow diagram representing an example of AI-enabled digital memorialization incorporating a sequential modeling process across multiple AI modules within the system, according to some embodiments; and

FIG. 7 illustrates a flow diagram representing an expanded embodiment of the AI-enabled digital memorialization process, with a focus on data flow and the dynamic integration of AI-generated content, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The present system and method allows for AI-enabled digital memorialization by integrating artificial intelligence, machine learning, natural language processing, age progression modeling, and holographic rendering to create interactive digital representations of individuals. The system operates through at least one computing device connected to a network and an application server that hosts an interactive memory system. The AI model processes and generates digital memorials based on stored user-provided data. The system is designed to receive, store, and process multiple data types, including text, images, videos, and other multimedia content, within a cloud-based interactive memory system.

To enable realistic and personalized digital interactions, the system develops a conversational AI model (conversational module) using a large language model trained on structured data extracted from the stored memories. The AI model processes user-provided text, images, and audiovisual data by first tokenizing them into structured representations, encoding them into vectorized embeddings, and applying self-attention training through transformer-based neural networks. This process allows the system to learn contextual dependencies and generate coherent, naturalistic responses. Fine-tuning techniques further optimize the model's ability to generate personalized and contextually appropriate conversations, reflecting the unique speech patterns, vocabulary, and sentiment of the deceased individual. The resulting conversational AI model is capable of generating text-based or audio-based interactions that accurately simulate the manner of speech and expressive tendencies of the original individual.

The system also incorporates an age progression model (age progression module) to predict and render age-related transformations of the deceased individual over time. The system extracts and tokenizes relevant multimedia data, encoding the tokenized information into a structured dataset suitable for predictive modeling. By leveraging deep learning-based self-attention mechanisms, the system refines the predictive model to account for morphological and phonetic changes associated with aging. The model is fine-tuned using a combination of historical demographic data and individual-specific traits, allowing it to generate progressively altered visual and auditory representations of the individual. This enables users to observe how their loved ones might have appeared had they lived beyond their documented age. The output model provides dynamically generated visualizations that adjust over time, incorporating elements such as natural hair graying, skin texture changes, and voice modulation based on predicted age-related transformations.

To further enhance the immersive experience, the system generates a holographic model (holographic module) of the individual by integrating the outputs from both the conversational model and the age progression model. The system tokenizes relevant conversational and visual data, encoding them into structured representations for AI processing. Through a sequence of self-attention training steps, the model refines the three-dimensional holographic details to improve facial accuracy, gesture fluidity, and real-time responsiveness. The holographic model undergoes iterative fine-tuning to enhance the realism of facial expressions and body movements, ensuring that the AI-generated holographic representation mimics natural human motion and expressions. The final rendering process produces a dynamically generated holographic output, which can be displayed through compatible augmented reality or holographic projection systems.

Beyond individual memorialization, the system supports the creation of focus groups related to digital memorialization, emotional well-being, and resilience. Users can participate in shared memory spaces where they interact with AI-generated memorials, exchange memories, and engage in support-driven communities. The system employs natural language processing to moderate discussions, detect emotional sentiment, and provide contextually relevant prompts to facilitate meaningful interactions via a sentiment engine. AI-driven analytics monitor engagement trends, adapting the AI-generated responses and discussion topics based on user participation patterns.

Security and privacy considerations are addressed through an advanced authentication and encryption framework. The system employs token-based security, such as JWT-based authentication, to validate user access and utilizes end-to-end encryption to safeguard stored and transmitted data. Cloud-based storage solutions, including distributed database architectures such as MongoDB, provide scalable and secure data management capabilities. Access control mechanisms allow users to define visibility settings for stored memories, ensuring that personal and sensitive data is protected according to individual privacy preferences.

The system is implemented as a software application that can be deployed across mobile and web platforms. A front-end interface, such as React Native or Lightning Web Runtime or Lightning Web Components (LWR/LWC), enables seamless cross-platform accessibility, while serverless infrastructure, such as AWS, powers the back-end computational processes. Data processing and storage rely on a combination of event-driven compute services, such as AWS Lambda, for scalable execution, media storage, such as S3, and structured data management, such as Salesforce Data Cloud. AI-driven functionalities, including conversational modeling and holographic generation, are powered by transformer-based neural networks, generative AI such as Salesforce Generative AI, and proprietary model fine-tuning techniques designed to optimize memory-based interactions.

The system further includes a recommendation engine designed to support emotional well-being and personal resilience. This engine analyzes user behavior, sentiment, and engagement patterns within the platform to deliver personalized suggestions, such as wellness resources, support group prompts, or guided interactions with digital memorials. A wellness check-in feature is also provided, allowing users to complete periodic surveys that assess mood, stress levels, and emotional state. These responses are used to generate tailored feedback and to adapt the AI-generated experiences accordingly.

The virtual memorial system enables users to create and curate dedicated memory spaces that preserve multimedia content, personal reflections, and AI-simulated interactions with loved ones. Users may organize content chronologically, thematically, or by emotional significance. The platform also supports both user-driven and AI-assisted tagging of media, enabling smart categorization of photos, videos, and memories based on individuals, topics, or emotional tone.

In some embodiments, the system integrates access to a network of mental health and grief support providers. Based on wellness check-in results or user preferences, the platform may recommend connecting with licensed counselors, grief coaches, or peer support groups, offering an additional layer of human-guided care alongside the AI-generated memorialization experience.

Various implementations of the system involve the technical field of digital memorialization including modeling, via a computing device implementing an artificial intelligence (AI) model, a conversational model based data within an interactive memory system; modeling, via the computing device implementing the AI model, an age progression model based on the interactive memory system; and generating, via the computing device implementing the AI model, a holographic model of an individual, wherein the holographic model is configured to replicate an individual based on the conversational model and the age progression model and are therefore necessarily rooted in computer technology. For example, the aforementioned steps are inherently computer-based and cannot be performed in the human mind. Additionally, the steps of the present system would be impossible to accomplish on pen and paper due to the volume of data being communicated and received over a network in real-time. In particular, the speed at which the steps of the present system occur to effectuate the disclosed method, system, or product would involve large-scale, continuous wireless communication of such data. That is, the steps of the present method, system, or product are impossible to accomplish on pen and paper, cannot be accomplished as a method of organizing human activity, and amount to significantly more than merely gathering, analyzing, and outputting data.

Implementations of the present system include implementing (executing, running, or deploying) one or more artificial intelligence models on a computing device wherein the computing device executes the artificial intelligence model's algorithms and mathematical functions on computer hardware using machine learning libraries. The computing device implements the artificial intelligence model when it performs tasks like training, making predictions, applying the model to data, decision-making, classification, or generating outputs based on inputs. In particular, the speed at which an artificial intelligence model analyzes and transforms data to effectuate the disclosed method, system, or product would involve large-scale, continuous transformation of such data. As such, the present system would be impossible to accomplish on pen and paper or in the human mind due to the volume of data being analyzed and transformed by the artificial intelligence model.

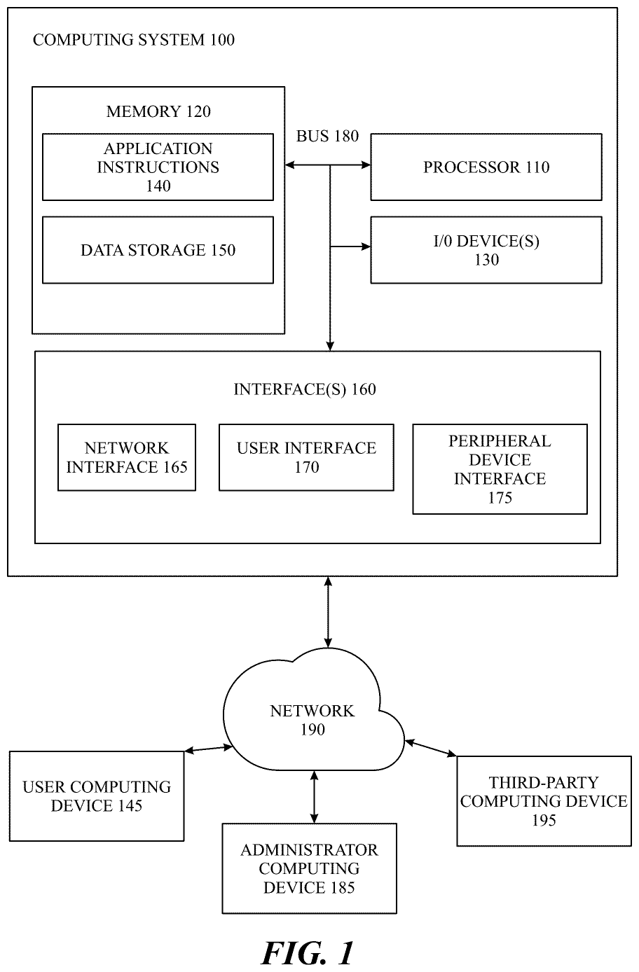

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to interact with the various functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

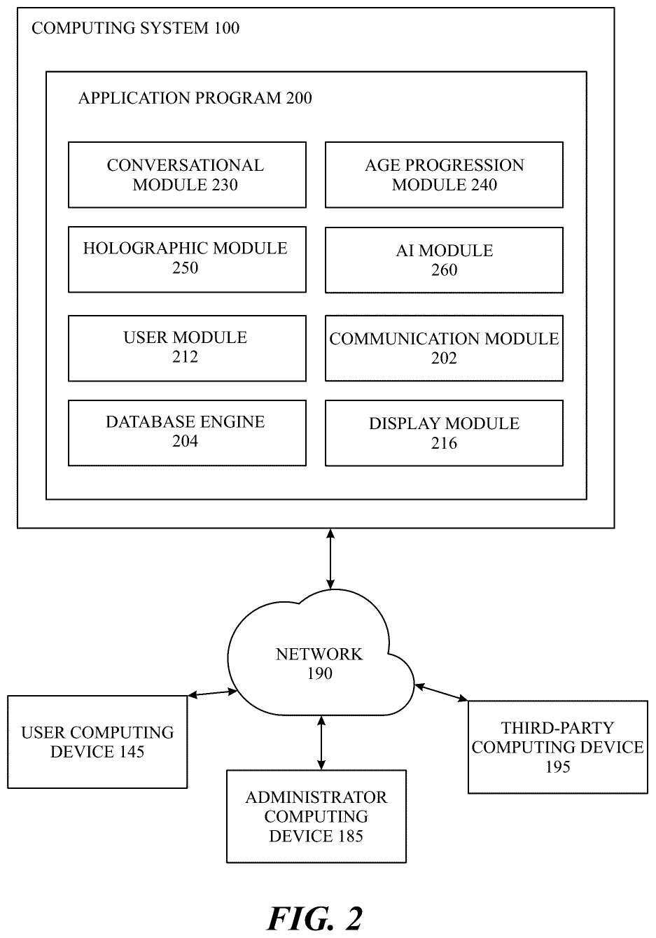

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a conversational module 230, an age progression module 240, a holographic module 250, an AI module 260, a communication module 202, a database engine 204, a user module 212, and a display module 216.

In some embodiments, the conversational module 230 module is configured to generate interactive, personalized conversations that simulate the speech patterns and expressive tendencies of a deceased individual. The conversational module 230 module operates using a transformer-based large language model trained on structured data derived from user-provided text, images, videos, and other multimedia content stored within the interactive memory system. To construct an accurate and contextually relevant conversational model, conversational module 230 first tokenizes the received data, breaking down textual input and metadata into structured representations. These tokenized data elements are then encoded into vectorized embeddings, capturing semantic and contextual relationships between words, phrases, and associated multimedia content. The encoded representations undergo self-attention training, a process facilitated by transformer-based neural networks that enable the model to analyze long-range dependencies in language, ensuring that the generated responses maintain coherence and relevance to the stored memories. Fine-tuning is performed on the conversational module 230 to enhance its ability to generate personalized and naturalistic responses. By employing domain-specific training techniques, the model is adjusted to reflect the unique speech patterns, vocabulary, and emotional expressions of the individual being memorialized. This fine-tuning process includes reinforcement learning and human-in-the-loop validation to refine conversational accuracy and ensure that the generated interactions align with the intended personality and sentiment.

In operation, the conversational module 230 allows users to engage in text-based or audio-based interactions with the digital representation of their loved one. The module dynamically adapts responses based on user inputs, retrieving relevant structured memories and synthesizing responses that align with the individual's historical conversational patterns. If the user provides ambiguous or open-ended prompts, the module leverages context retrieval mechanisms to generate responses that are contextually appropriate and sentiment-aware. To further enhance realism, the conversational module 230 incorporates multimodal processing, integrating speech synthesis models that convert text-based outputs into natural-sounding voice interactions. These speech synthesis models are trained to replicate the tonality, cadence, and emotional variations of the individual, creating a more immersive and emotionally resonant memorialization experience. Additionally, the module supports interactive learning, allowing users to contribute new information that can be integrated into the memory database, further refining the model's conversational accuracy over time.

In some embodiments, the age progression module 240 is configured to predict and simulate the visual and auditory aging process of an individual, creating progressively altered representations that reflect natural age-related transformations. This module integrates deep learning-based self-attention mechanisms with structured multimedia data to generate realistic depictions of how an individual's appearance and voice might evolve over time. To develop an accurate age progression model, age progression module 240 first tokenizes received multimedia data, including images, video, and audio recordings. This tokenization process extracts structural and feature-based elements from the data, converting them into vectorized embeddings that represent facial morphology, skin texture, voice modulation, and other physiological attributes associated with aging. The embeddings are then processed using convolutional neural networks (CNNs) and transformer-based models to analyze patterns and predict age-related changes.

The age progression module 240 employs self-attention training to refine the predictive accuracy of age transformations. By leveraging historical demographic data and individual-specific characteristics, the model adapts its outputs to account for genetic factors, environmental influences, and lifestyle patterns that impact aging. The training data is continuously updated with newly available datasets, ensuring that the model remains robust and adaptive to diverse populations. Fine-tuning techniques enhance the personalization of the age progression model. The module applies generative adversarial networks (GANs) to synthesize high-fidelity age progression images that maintain the individual's unique facial features while integrating age-related modifications, such as skin wrinkling, hair graying, and facial structure evolution. Additionally, audio processing models simulate changes in vocal tonality and pitch, allowing the system to generate voice outputs that mirror the natural aging process.

In real-time operation, age progression module 240 dynamically generates age-evolved visual and auditory representations in response to user interactions. Users can specify an age range or progression timeline, prompting the module to produce corresponding visual and audio outputs that align with the requested parameters. The system ensures continuity in personal traits across different age stages, maintaining identity coherence throughout the progression process. The age progression module 240 seamlessly integrates with the conversational module 230 and the holographic rendering system, allowing for the creation of interactive, age-adaptive digital memorials. When combined with conversational AI, the module enables voice interactions that reflect the speech patterns of an individual at different life stages, enhancing the realism and engagement of digital memorial experiences.

In some embodiments, the holographic module 250 is configured to generate dynamic, three-dimensional representations of individuals based on data from the conversational module 230 and the age progression module 240. The holographic module 250 module integrates AI-driven rendering techniques with real-time processing capabilities to produce lifelike holographic outputs that reflect an individual's unique physical attributes, expressions, and mannerisms.

The process begins with the tokenization of input data, which includes facial images, videos, and motion-capture metadata extracted from the interactive memory system. These data points are encoded into structured vector embeddings that represent facial geometry, skeletal motion, and expressive traits. The holographic module 250 then applies a transformer-based neural network to analyze and synthesize the captured features, ensuring that the generated holographic model maintains a high degree of realism and alignment with the original individual's likeness.

To enhance facial accuracy and gesture fluidity, the module incorporates self-attention training, refining the three-dimensional mesh to capture subtle nuances in facial expressions, eye movements, and body posture. This ensures that the holographic model remains responsive to real-time interactions while preserving the individual's authentic appearance and mannerisms.

The holographic module 250 also supports integration with augmented reality (AR) and virtual reality (VR) platforms, enabling immersive user experiences. Through adaptive rendering techniques, the module optimizes computational efficiency while maintaining high-resolution fidelity in diverse display environments, including holographic projectors, AR glasses, and VR headsets. The holographic module 250 is configured to support immersive interaction across a range of display technologies, including VR headsets, AR devices, holographic projectors, and mobile or desktop screens. In VR environments, users can engage with fully rendered, AI-generated holographic representations of loved ones within virtual memorial spaces, allowing for emotionally resonant, interactive experiences. When used with AR, the system overlays lifelike holograms into the user's physical environment through smart glasses or mobile devices, enabling natural interactions in real-world contexts. The holographic module 250 dynamically adjusts to the capabilities of each display method, while the AI module 260 ensures real-time responsiveness, voice synchronization, and gesture-based engagement. This flexible, multimodal compatibility allows users to access personalized digital memorials in a format and environment that best fits their preferences and available technology. For voice synthesis, the module leverages deep learning-based speech generation models that replicate the individual's vocal patterns. By utilizing pre-recorded audio samples and text-to-speech AI processing, the system generates voice outputs that synchronize with the holographic representation's lip movements, ensuring seamless audiovisual alignment. The holographic module 250 dynamically adjusts to real-time user interactions. Users can engage with the holographic model through voice commands, gesture-based inputs, or predefined interaction sequences. The module's AI-driven adaptability enables the holographic representation to respond naturally, creating an interactive and personalized experience.

In some embodiments, the AI module 260 module is configured to serves as the engine for the system, orchestrating the functionalities of the conversational module 230, the age progression module 240, and the holographic module 250. The AI module 260 module leverages a combination of transformer-based neural networks, deep learning techniques, and multimodal data processing to generate realistic, contextually accurate digital interactions. The AI module 260 processes structured and unstructured data, including text, images, videos, and audio recordings, to create highly personalized and adaptive digital experiences. The AI module 260 module tokenizes and encodes incoming data, converting it into a format suitable for AI-driven analysis and synthesis. This process enables the system to extract meaningful patterns, relationships, and contextual dependencies from the stored memories.

In its interaction with the conversational module 230, the AI module 260 generates contextually relevant and emotionally resonant responses. By applying natural language processing (NLP) and self-attention training, it ensures that the generated dialogue mirrors the speech patterns, vocabulary, and expressive tendencies of the individual being memorialized. The AI module 260 continuously refines its conversational output through reinforcement learning, enhancing the authenticity and coherence of the simulated interactions.

With the age progression module 240, the AI module 260 facilitates predictive modeling of an individual's visual and auditory transformations over time. Using historical demographic data, genetic factors, and environmental influences, it guides the self-attention mechanisms and generative adversarial networks (GANs) in producing realistic age-progressed images and voice simulations. This integration allows for a seamless transition between different life stages, enabling users to visualize how their loved ones might have aged.

The AI module 260 also plays a role in the operation of the holographic module 250. The AI module 260 module provides the necessary data inputs and real-time computational adjustments required to generate dynamic, three-dimensional holographic representations. Through AI-driven rendering and deep learning-based voice synthesis, the AI module 260 module ensures that the holographic model aligns with the individual's physical attributes, movements, and vocal tonality. Additionally, it enables real-time adaptability, allowing the holographic representation to respond naturally to user inputs, whether through voice commands, gestures, or interactive sequences.

In this way, the AI module 260 enables seamless interoperability between the conversational module 230, the age progression module 240, and the holographic module 250. This interconnected framework enhances the realism and emotional depth of digital interactions, providing users with an immersive and meaningful experience in preserving and engaging with the memories of their loved ones.

In some embodiments, the communication module 202 is configured for receiving, processing, and transmitting a user command and/or one or more data streams. In such embodiments, the communication module 202 performs communication functions between various devices, including the user computing device 145 of FIG. 1, the administrator computing device 185 of FIG. 1, and a third-party computing device 195 of FIG. 1. In some embodiments, the communication module 202 is configured to allow one or more users of the system, including a third-party, to communicate with one another. In some embodiments, the communications module 202 is configured to maintain one or more communication sessions with one or more servers, the administrative computing device 185 of FIG. 1, and/or one or more third-party computing device(s) 195 of FIG. 1. In some embodiments, the communication module 202 may allow users and administrators to communicate with one another.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

The user module 212 may store user preferences including the user account information, historical usage data, user personal information, and the like. The user module 212 may facilitate the creation of user's profiles for users, administrators, and others.

In some embodiments, the display module 216 is configured to display one or more graphic user interfaces, including, e.g., one or more user interfaces. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 displays information, notifications, and alerts to the user device which can be viewed and acknowledged by the user.

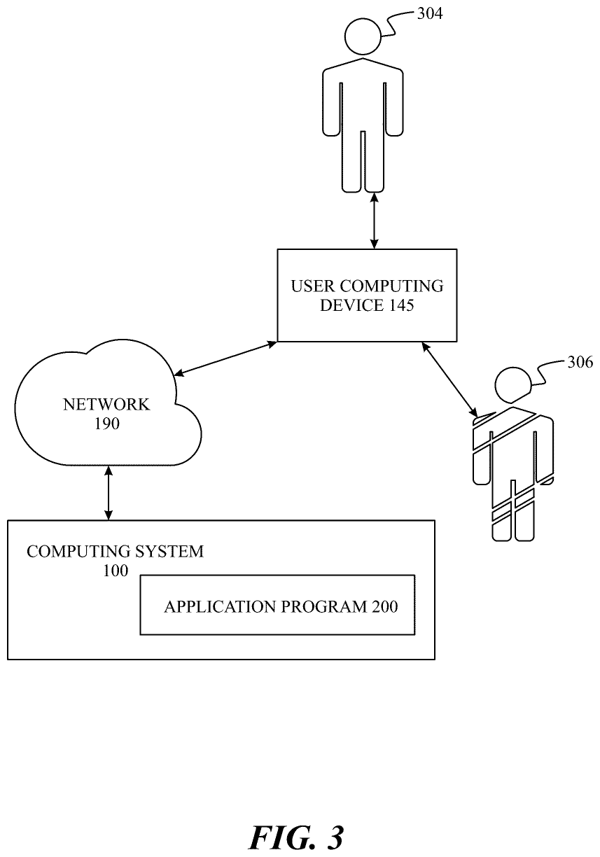

FIG. 3 illustrates a block diagram of a method of generating a holographic model 306 based on input user data. The method may include receiving user-provided text, images, videos, and other multimedia content from a user 304 via the user computing device 145. The user provided data is communicated over network 190 to the computing system 100 executing application program 200 depicted in FIGS. 1 and 2. Application program 200 may tokenize data processed by the conversational model and the age progression model including encoding tokenized data; self-attention training the AI module 260 of FIG. 2 based on encoded data; fine-tuning training data; and generating a holographic model 306 configured to generate age-based images or holograms based on the passage of time. The holographic model 306 may be communicated to user computing device 145 or other device to be displayed to user 304.

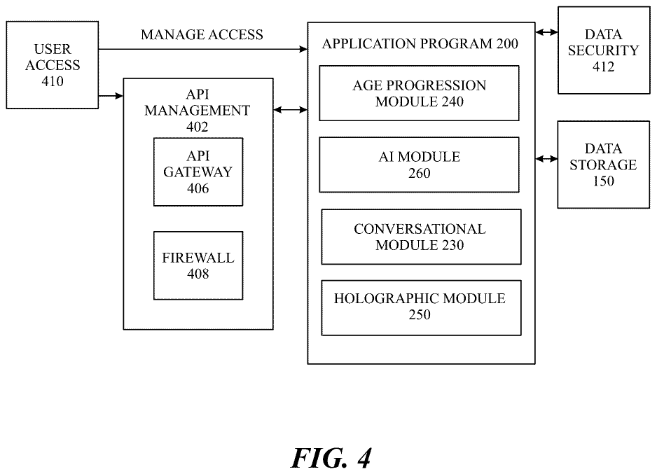

FIG. 4 illustrates a block diagram of a method of user data processing architecture including a user access point 410, such as the user computing device 145 of FIGS. 1-3, and which may be interfaced with an API management 402 system. The API management 402 layer consists of an API gateway 406, which facilitates communication between the user and the application program 200, and a firewall 408, which ensures secure and controlled access to system resources. Application program 200 includes the conversational module 230 configured to process user-provided data to generate AI-driven, naturalistic interactions simulating the speech and personality of a memorialized individual, the age progression module 240 configured to utilize deep learning techniques to predict and render age-based transformations of an individual's visual and auditory characteristics over time, the holographic module 250 configured to integrate outputs from the conversational and age progression modules to generate dynamic, three-dimensional holographic representations, and the AI module 260 configured to serve as the central processing unit, orchestrating data interpretation, natural language understanding, and model refinement to ensure seamless interactions across modules. Data security and integrity are maintained through data security 412 module, which enforces authentication and encryption protocols to protect user information, user access, etc. Additionally, data storage 150 provides a structured repository for storing multimedia data, AI training datasets, generated holograms, and user-generated inputs essential for generating digital memorials.

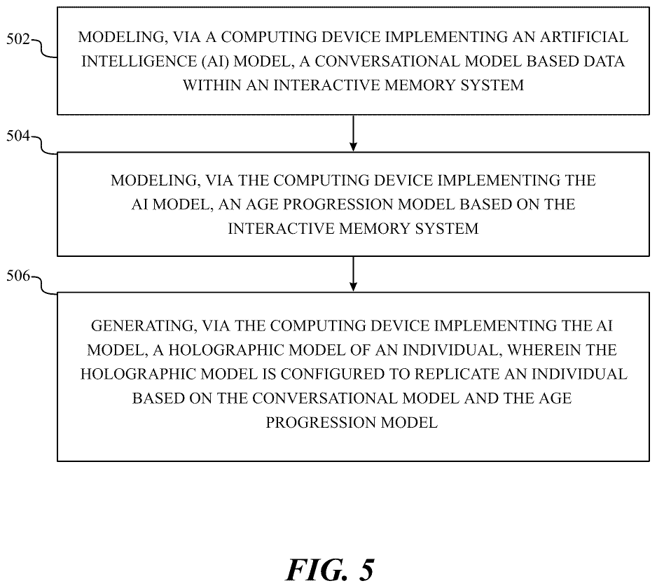

FIG. 5 illustrates a block diagram of a method of artificial-intelligence enabled digital memorialization. The method may include, in step 502 may include modeling, via a computing device implementing an artificial intelligence (AI) model, a conversational model based data within an interactive memory system. Step 504 may include modeling, via the computing device implementing the AI model, an age progression model based on the interactive memory system. Step 506 may include generating, via the computing device implementing the AI model, a holographic model of an individual, wherein the holographic model is configured to replicate an individual based on the conversational model and the age progression model.

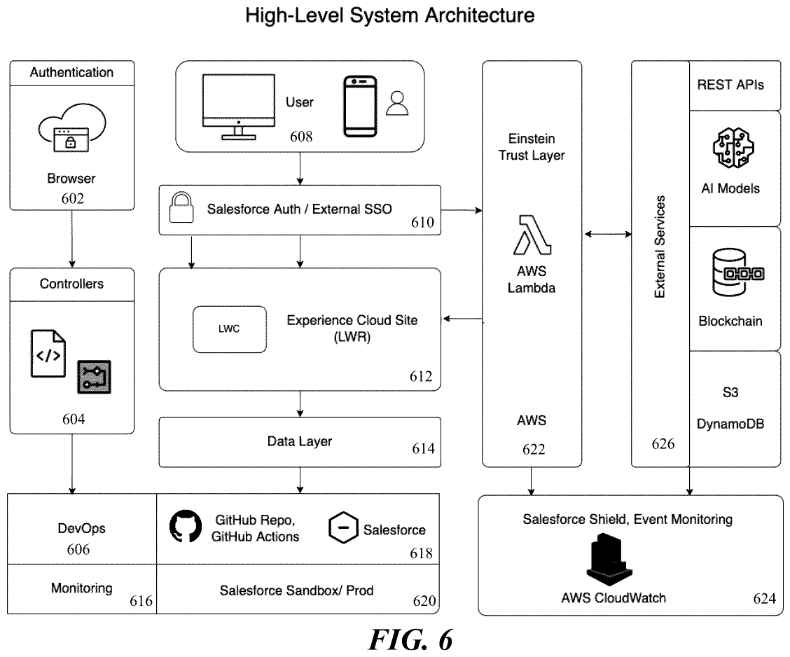

FIG. 6 illustrates a high-level system architecture for implementing the AI-enabled digital memorialization platform, showing the flow of user interaction, data processing, and external services integration across a secure, scalable cloud-based infrastructure. The architecture may include User 608, who accesses the system via desktop, mobile, or other authenticated identity. Authentication is managed through an External SSO 610, such as Salesforce Auth/External SSO, which provides secure access to the Experience Cloud site 612. Users 608 initiate access via a Browser 602, authenticated through a secure layer that may involve an external identity provider, such as Salesforce 618. The Experience Cloud Site 612, such as LWR, serves as the front-end experience where users interact with memorial content, conduct wellness check-ins, view holograms, and engage with AI-driven features. User interface development tools, such as LWC, within the Experience Cloud site enables dynamic, component-based UI rendering, providing an interactive and personalized user experience. Beneath the front-end interface lies the Data Layer 614, which captures and manages structured and unstructured data such as text, images, videos, and audio recordings related to memorialized individuals. This data is used by AI models for training and response generation. Controllers 604 handle application logic and coordinate communication between the user interface and backend services. Controllers 604 ensure that user actions, such as uploading media or initiating a holographic interaction, are properly processed and routed through the system. The event-driven compute service such as AWS Lambda 622 service enables serverless computation and acts as an intermediary between application development platforms, such as Salesforce, and external services. It processes requests from the Experience Cloud 612 site and communicates with external APIs and databases. This layer is protected by secure AI architectures, such as an Einstein Trust Layer 622, which ensures compliance with data governance, security policies, and trust frameworks. External Services 626 include a suite of third-party integrations accessible via REST APIs, including: AI Models used for conversational modeling, age progression, sentiment analysis, and personalization; blockchain, optionally used for secure and immutable storage of digital memorial records and database services, such as S3/DynamoDB, used for storage and retrieval of large-scale media and structured data. Monitoring 616 and observability are managed via security tools such as, Salesforce Shield, Event Monitoring, and AWS CloudWatch 624, which provide detailed audit trails, system diagnostics, and performance metrics for maintaining system reliability and compliance. The system is supported by DevOps 606 infrastructure, including GitHub Repositories and GitHub Actions, for continuous integration and deployment of new features. Code and system configuration are version-controlled and deployed into productions environments, such as Salesforce Sandbox/Production 620 environments, to support iterative development and secure production release cycles.

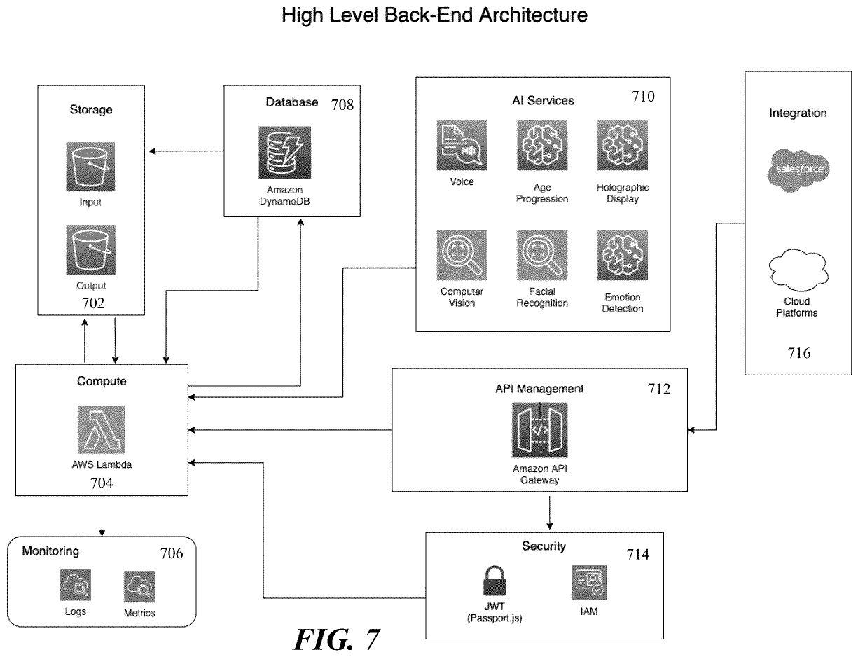

FIG. 7 illustrates a high-level back-end architecture of the AI-enabled digital memorialization platform. This architecture outlines the core data processing, storage, compute, AI services, and integration layers that support the generation and delivery of personalized digital memorial experiences. At the foundation of the system is the Compute layer 704, which may be powered via AWS Lambda, which provides scalable, serverless execution of the application's functions. Compute layer 704 functions process user inputs, trigger AI workflows, interact with the database and storage layers, and coordinate the orchestration of AI modules, such as conversational modeling, age progression, and holographic generation. Storage 702 may be handled through object storage services, such as AWS S3, shown here with separate Input and Output buckets. The Input bucket stores raw media and memory data uploaded by users—such as text, images, and video—while the Output bucket stores processed results such as vectorized embeddings, generated holographic assets, or audio files. This enables efficient media handling and supports asynchronous processing across services. The Database layer 708 may be a fully managed NoSQL database, such as Amazon DynamoDB, optimized for fast and scalable access to structured memory records, embeddings, user profiles, AI training data, and session logs. Database layer 708 enables low-latency reads and writes, ensuring responsiveness for both real-time user interaction and background AI processing.

The AI Services 710 block includes functional modules that support the memorialization process:
Voice: For generating and synthesizing speech aligned with the individual's tone and cadence.
Age Progression: For modeling realistic age-based visual and auditory changes over time.
Holographic Display: For generating immersive 3D representations.
Computer Vision: For analyzing and extracting features from visual content such as facial features, environments, or objects in photos.
Facial Recognition: For identifying individuals and associating them with stored memories.
Emotion Detection: For interpreting sentiment in user interactions or visual media to adapt responses and suggestions.

These services are triggered and managed via Compute layer 704, which routes requests to appropriate AI models and aggregates the results. API Management 712 is handled through scalable API services, such as Amazon API Gateway, which exposes secure and scalable endpoints for front-end and third-party interaction. API Management 712 handles all inbound and outbound API calls between the Experience Cloud site (or other front ends), external services, and internal compute functions. Security 714 is enforced through a combination of JWT (JSON Web Tokens) using libraries like Passport. js for session authentication, and IAM (Identity and Access Management) for managing roles, permissions, and secure access to cloud resources and data. Monitoring 706 is implemented with centralized access to Logs and Metrics, allowing administrators to monitor usage patterns, performance, error rates, and infrastructure health. These insights help ensure system reliability and inform model improvements. The system includes Integration 716 with external platforms, such as Salesforce and other Cloud Platforms, allowing synchronization with user accounts, wellness data, or content management systems. This integration supports broader use cases including support group coordination, recommendation delivery, or memory sharing.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrases “computing device” or “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A computer-implemented method of artificial-intelligence enabled digital
memorialization, the method comprising:
modeling, via a computing device implementing an artificial intelligence (AI) model, a conversational model based data within an interactive memory system;
modeling, via the computing device implementing the AI model, an age progression model based on the interactive memory system; and
generating, via the computing device implementing the AI model, a holographic model of an individual, wherein the holographic model is configured to replicate an individual based on the conversational model and the age progression model.

2. The computer-implemented method of claim 1, wherein the interactive memory system is configured to receive and store at least one of text, image, video, or multimedia data.

3. The computer-implemented method of claim 2, wherein the AI model comprises a large language model.

4. The computer-implemented method of claim 3, wherein the modeling the
conversational model comprises:
tokenizing at least one of text, image, video, or multimedia data;
encoding tokenized data;
self-attention training based on encoded data;
fine-tuning training data; and
generating the conversational model configured to simulate text or audio-based conversation.

5. The computer-implemented method of claim 3, wherein the modeling the age
progression model comprises:
tokenizing at least one of text, image, video, or multimedia data;
encoding tokenized data;
self-attention training based on encoded data;
fine-tuning training data; and
generating the age progression model configured to predict changes in appearance or speech based on the passage of time.

6. The computer-implemented method of claim 3, wherein the large language model comprises a transformer-based neural network.

7. The computer-implemented method of claim 1, wherein the generating the
holographic model comprises:
tokenizing data associated with the conversational model and the age progression model;
encoding tokenized data;
self-attention training based on encoded data;
fine-tuning training data; and
generating the holographic model configured to generate age-based images or holograms based on the passage of time.

8. The computer-implemented method of claim 1, further comprising creating one or more focus groups related to at least one of digital memorialization, well-being, or resilience.

9. A system comprising:
at least one computing device in operable communication with a network;
an application server in operable communication with the at least one computing device over the network, the application server configured to host an application program configured to:
model, via an artificial intelligence (AI) model, a conversational model based data within an interactive memory system;
model, via the AI model, an age progression model based on the interactive memory system; and
generate, via the AI model, a holographic model of an individual, wherein the holographic model is configured to replicate an individual based on the conversational model and the age progression model.

10. The system of claim 9, wherein the AI model comprises a large language model.

11. The system of claim 10, wherein the modeling the conversational model
comprises:
tokenizing at least one of text, image, video, or multimedia data;
encoding tokenized data;
self-attention training based on encoded data;
fine-tuning training data; and
generating the conversational model configured to simulate text or audio-based conversation.

12. The system of claim 11, wherein the modeling the age progression model
comprises:
tokenizing at least one of text, image, video, or multimedia data;
encoding tokenized data;
self-attention training based on encoded data;
fine-tuning training data; and
generating the age progression model configured to predict changes in appearance or speech based on the passage of time.

13. The system of claim 12, wherein the generating the holographic model:
tokenizing data associated with the conversational model and the age progression model;
encoding tokenized data;
self-attention training based on encoded data;
fine-tuning training data; and
generating the holographic model configured to generate age-based images or holograms based on the passage of time.

14. The system of claim 9, wherein the application program is further configured to provide personalized suggestions for emotional support and resilience based on user engagement and behavioral trends within the platform via a recommendation engine.

15. The system of claim 9, wherein the application program is further configured to perform sentiment analysis via natural language processing to moderate discussions, detect emotional sentiment, identify relevant resilience groups, and provide contextually relevant prompts to facilitate interactions via a sentiment engine.

16. The system of claim 9, wherein the application program is further configured to conduct a wellness check-in configured to allow users to complete periodic surveys that assess mood, stress levels, and emotional state that are used to generate tailored feedback and to adapt the AI-generated experiences.

17. A software product comprising at least one computer readable storage media having application instructions collectively stored on the at least one computer readable storage media, the application instructions executable to:
model, via an artificial intelligence (AI) model comprising a transformer-based neural network, a conversational model based data within an interactive memory system;
model, via the AI model, an age progression model based on the interactive memory system;
generate, via the AI model, a holographic model of an individual, wherein the holographic model is configured to replicate an individual based on the conversational model and the age progression model and;
create one or more focus groups related to at least one of digital memorialization, well-being, or resilience.

18. The software product of claim 17, wherein the interactive memory system is configured to receive and store at least one of text, image, video, or multimedia data.

19. The software product of claim 18, wherein the AI model comprises a large language model.

20. The software product of claim 19, wherein the modeling the conversational model comprises:
tokenizing at least one of text, image, video, or multimedia data;
encoding tokenized data;
self-attention training based on encoded data;
fine-tuning training data; and
generating the conversational model configured to simulate text or audio-based conversation.
